(19) United States
(12) Patent Application Publication
(10) Pub. No.: US 2015/0282268 A1
(43) Pub. Date: Oct. 1, 2015

(54) LED DRIVER, AND METHOD AND DEVICE FOR CONTROLLING FIXED VALUE OF LED DRIVER

(71) Applicant: INVENTRONICS (HANGZHOU), INC., Hangzhou, Zhejiang (CN)

(72) Inventors: Guichao Hua, Hangzhou (CN); Liang'an Ge, Hangzhou (CN); Daifu Xiong, Hangzhou (CN)

(73) Assignee: INVENTRONICS (HANGZHOU), INC., Hangzhou, Zhejiang (CN)

(21) Appl. No.: 14/647,018

(22) PCT Filed: Nov. 21, 2013
(86) PCT No.: PCT/CN2013/087573

§ 371 Date: May 22, 2015

(30) Foreign Application Priority Data
Nov. 28, 2012 (CN) 201210499514.7

(51) Int. Cl. H05B 33/08

(52) U.S. Cl. CPC H05B 33/0845

(57) ABSTRACT

Provided in an embodiment of the present invention are an LED driver, and method and device for controlling the fixed value of the LED driver, the method comprising: detecting whether an existing terminal of an LED driver inputs a control signal; when the control signal is detected, determining the fixed value of the LED driver according to the control signal; when the LED driver is an LED driver having no dimming function, the fixed value is the rated current of the LED driver; when the LED driver is an LED driver having a dimming function, the fixed value includes the upper limit or lower limit of the output current value of the LED driver. The method, device and the LED driver provided in the embodiment of the present invention can save LED driver costs.

The present application claims the priority to Chinese Patent Application No. 201210499514.7, titled “LED DRIVER, AND METHOD AND DEVICE FOR CONTROLLING FIXED VALUE OF LED DRIVER”, filed with the Chinese State Intellectual Property Office on Nov. 28, 2012, which is incorporated by reference in its entirety herein.

### FIELD

The present disclosure relates to the field of an LED driver, and particularly to an LED driver, and a method and a device for controlling a fixed value of the LED driver.

### BACKGROUND

In the conventional art, there are three types of LED drivers. The first type of LED driver includes an input line Va, an input line Vb, a positive output line Vo+ and a negative output line Vo−. The second type of LED driver includes an input line Va, an input line Vb, a positive output line Vo+, a negative output line Vo−, a dimming line Dim and a ground line GND. The third type of LED driver includes an input line Va, an input line Vb, a positive output line Vo+, a negative output line Vo−, a dimming line Dim, a ground line GND and an auxiliary power line Vcc.

In implementation of the present disclosure, it is discovered by the applicant that, the first type of LED driver in the conventional art has a constant current output or a constant voltage output, and an unchangeable rated current or an unchangeable rated voltage. Multiple LED drivers having different rated currents or rated voltages are needed in case that different rated currents or rated voltages are needed. Output currents of the second and third type of LED drivers in the conventional art vary with a voltage between the dimming line Dim and the ground GND. However, an upper limit and a lower limit of the current variation range can not be changed. Accordingly, multiple LED drivers having different upper limits and the lower limits are needed in case that different current variation ranges are needed. The upper limit and the lower limit of the current value range, and the rated current of the LED driver are each referred to as a fixed value.

Multiple LED drivers having different fixed values may be needed in a same occasion. It results in a high cost of LED drivers.

### SUMMARY

In this regard, a method and a device for controlling a fixed value of an LED driver are provided according to the present disclosure, to solve the problem in the conventional art that a high cost of LED drivers caused by multiple LED drivers having different fixed values which may be needed in a same occasion.

In order to achieve the above-described object, following technical solutions are provided according to the present disclosure.

A control method for controlling a fixed value of an LED driver is provided, which includes:

detecting whether a control signal is input to existing terminals of the LED driver, wherein the LED driver comprises a first pair of terminals and a second pair of terminals, the first pair of terminals comprises an input line Va and an input line Vb, the second pair of terminals comprises a positive output line Vo+ and a negative output line Vo−, the existing terminals are any pair of terminals on the LED driver, and the control signal is different from an output signal or an input signal of the terminals of the LED driver operating normally; and

determining a fixed value of the LED driver according to the control signal, in a case that the control signal is detected, wherein the fixed value is a rated current of the LED driver in a case that the LED driver is an LED driver having no dimming function; or the fixed value comprises an upper limit or a lower limit of an output current value of the LED driver in a case that the LED driver is an LED driver having a dimming function.

The LED driver may further include a third pair of terminals, or the LED driver further may further include a third pair of terminals and a fourth pair of terminals, wherein the third pair of terminals may include a dimming line Dim and a ground line GND, and the fourth pair of terminals may include a ground line GND and an auxiliary power line Vcc.

The process of determining the fixed value of the LED driver according to the control signal may include:

analyzing a characteristic parameter of the control signal, wherein the characteristic parameter comprises one or more of an amplitude, a frequency, a duty cycle, high-level time and low-level time; and

acquiring the fixed value corresponding to the characteristic parameter.

The process of acquiring the fixed value corresponding to the characteristic parameter may include:

controlling, according to the characteristic parameter, the output current of the LED driver to vary within a first range; and

controlling the fixed value of the LED driver to be the output current value of the LED driver at a time instant when inputting of the control signal is stopped, in a case that it is detected that the inputting of the control signal is stopped.

The process of acquiring the fixed value corresponding to the characteristic parameter may include:

controlling, according to the characteristic parameter, the output current of the LED driver to vary within a second range; and

controlling the fixed value of the LED driver to be the output current value of the LED driver at a time instant when a definitive fixed value signal begins to be input, in a case that it is detected that the definitive fixed value signal is input to terminals of the LED driver, wherein the definitive fixed value signal has a different characteristic parameter from that of the control signal, or the definitive fixed value signal has a different characteristic parameter value from that of the control signal.

The process of acquiring the fixed value corresponding to the characteristic parameter may include:

acquiring the fixed value corresponding to the characteristic parameter according to a correspondence between the characteristic parameter and the fixed value.

A device for controlling a fixed value of an LED driver is provided, which includes:

a detecting module, configured to detect whether a control signal is input to existing terminals of the LED driver, wherein the LED driver comprises a first pair of terminals and a second pair of terminals, the first pair of terminals comprises an input line Va and an input line Vb, the second pair of terminals comprises a positive output line Vo+ and a negative output line Vo−, the existing terminals are any pair of terminals on the LED driver, and the control signal is a signal different from an output signal or an input signal on the terminals of the LED driver operating normally; and

a determining module, configured to determine a fixed value of the LED driver according to the control signal in a case that a detected result of the detecting module is yes: the fixed value is a rated current of the LED driver in a case that the LED driver is an LED driver having no dimming function; the fixed value comprises an upper limit or a lower limit of an output current value of the LED driver in a case that the LED driver is an LED driver having a dimming function.

The LED driver may further include a third pair of terminals, or the LED driver further may include a third pair of terminals and a fourth pair of terminals, wherein the third pair of terminals may include a dimming line Dim and a ground line GND, and the fourth pair of terminals may include a ground line GND and an auxiliary power line Vcc.

The determining module may include:

a first analyzing unit, configured to analyze a characteristic parameter of the control signal, wherein the characteristic parameter comprises one or more of an amplitude, a frequency, a duty cycle, high-level time and low-level time; and

an acquiring unit, configured to acquire the fixed value corresponding to the characteristic parameter.

The acquiring module may include:

a first control sub-unit, configured to control, according to the characteristic parameter, the output current of the LED driver to vary within a first range; and

a second control sub-unit, configured to control the fixed value of the LED driver to be the output current value of the LED driver at a time instant when inputting of the control signal is stopped, in a case that it is detected that the inputting of the control signal is stopped.

The acquiring unit may include:

a first control sub-unit, configured to control, according to the characteristic parameter, the output current of the LED driver to vary within a second range; and

a third control sub-unit, configured to control the fixed value of the LED driver to be the output current value of the LED driver at a time instant when a definitive fixed value signal begins to be input in a case that it is detected that the definitive fixed value signal is input by terminals of the LED driver, wherein the definitive fixed value signal has a different characteristic parameter from that of the control signal, or the definitive fixed value signal has a different characteristic parameter value from that of the control signal.

The acquiring unit may be configured to acquire the fixed value corresponding to the characteristic parameter according to a correspondence between the characteristic parameter and the fixed value

An LED driver is provided, which includes the device according to any one of the above-described LED driver.

It can be seen from the above-described technical solution, as compared with the conventional art, by using the method for controlling the fixed value of the LED driver according to the embodiments of the present disclosure, an output rated current value may be changed according to the control signal in a case that the LED driver is an LED driver having no dimming function; and an upper limit or a lower limit of an output current value may be changed according to the control signal in a case that the LED driver is an LED driver having a dimming function. Accordingly, only one LED driver is needed in an occasion where multiple LED drivers having different upper limits, lower limits or rated currents were needed, and cost of LED drivers is saved. According to the embodiments of the present disclosure, the control signal is input to the existing terminals of the LED driver and no special lead is needed, thus the cost of the LED driver is further saved.

### BRIEF DESCRIPTION OF THE DRAWINGS

The drawings to be used in the description of the embodiments and the conventional art will be described briefly as follows, so that the technical solutions according to the embodiments of the present disclosure or the conventional art will become clearer. It is obvious that the drawings in the following description are merely a few embodiments of the present disclosure. For those skilled in the art, other drawings may be obtained without any creative work according to these accompanying drawings.

FIG. 1 is a flow chart of a first control method for controlling a fixed value of an LED driver according to an embodiment of the present disclosure;

FIG. 2 is a flow chart of a second control method for controlling a fixed value of an LED driver according to an embodiment of the present disclosure;

FIG. 3 is a flow chart of a first method for acquiring a fixed value corresponding to a characteristic parameter according to an embodiment of the present disclosure;

FIG. 4 is a flow chart of a second method for acquiring a fixed value corresponding to a characteristic parameter according to an embodiment of the present disclosure; and

FIG. 5 is a structural schematic diagram of a device for controlling a fixed value of an LED driver according to an embodiment of the present disclosure.

### DETAILED DESCRIPTION

The technical solutions according to the embodiments of the present disclosure will be described clearly and completely as follows in conjunction with the drawings. It is obvious that the described embodiments are merely a few of the embodiments according to the present disclosure. Other embodiments based on the embodiments in the present disclosure and obtained by those skilled in the art without any creative work fall into the scope of the present disclosure.

### First Embodiment

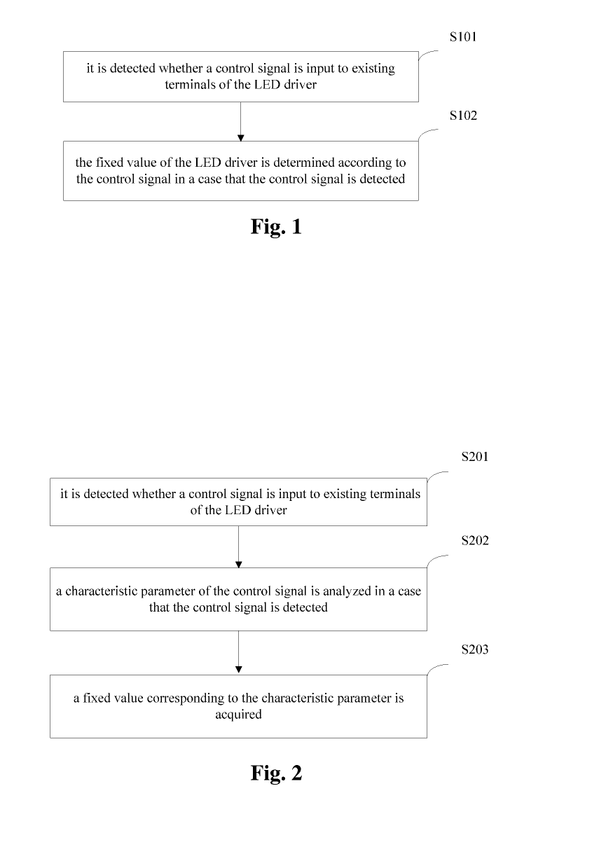

Referring to FIG. 1, FIG. 1 is a flow chart of a first control method for controlling a fixed value of an LED driver according to an embodiment of the present disclosure, and the method may include steps S101 and S102 as follows.

In step S101, it is detected whether a control signal is input to existing terminals of the LED driver.

In the conventional art, there are three types of LED drivers. The first type of LED driver includes an input line Va, an input line Vb, a positive output line Vo+ and a negative output line Vo−. For the first type of LED driver, according to the embodiment of the present disclosure, the control signal may be input between the input line Va and the input line Vb, or between the positive output line Vo+ and the negative output line Vo−. The second type of LED driver includes an input line Va, an input line Vb, a positive output line Vo+, a negative output line Vo−, a dimming line Dim and a ground line GND. For the second type of LED driver, according to the embodiment of the present disclosure, the control signal may be input between the input line Va and the input line Vb, between the positive output line Vo+ and the negative output line Vo−, or between the dimming line Dim and the ground line GND. The third type of LED driver includes an input line Va, an input line Vb, a positive output line Vo+, a negative output line Vo−, a dimming line Dim, a ground line GND and an auxiliary power line Vcc. For the third type of LED driver, according to the embodiment of the present disclosure, the control signal may be input between the input line Va and the input line Vb, between the positive output line Vo+ and the negative output line Vo−, between the dimming line Dim and the ground line GND, or between the ground line GND and the auxiliary power line Vcc.

Generally, when the LED driver operates normally, an alternating voltage is input between the input line Va and the input line Vb, a direct current is output between the positive output line Vo+ and the negative output line Vo−, a dimming signal is input between the dimming line Dim and the ground line GND, and a direct voltage is output between the auxiliary power line Vcc and the ground line GND.

The terminals as described in step S101 may be any one of a pair of the input line Va and the input line Vb, a pair of the positive output line Vo+ and the negative output line Vo−, a pair of the dimming line Dim and the ground line GND, and a pair of the ground line GND and the auxiliary power line Vcc. Moreover, the control signal described in step S101 is a signal different from the output signal or the input signal of the terminals of the LED driver operating normally.

The input line Va and the input line Vb are referred to as a first pair of terminals, the positive output line Vo+ and the negative output line Vo− are referred to as a second pair of terminals, the dimming line Dim and the ground line GND are referred to as a third pair of terminals, and the ground line GND and the auxiliary power line Vcc are referred to as a fourth pair of terminals.

If the terminals as described in step S101 are a pair of terminals to which a signal is input when the LED driver operates normally, “the control signal is different from the input signal of the terminals of the LED driver operating normally” means that: the control signal may have a parameter different from that of the input signal of the terminals of the LED driver operating normally, or may be in a type different from that of the input signal of the terminals of the LED driver operating normally. The control signal may be a signal having a parameter different from that of the input signal in normal operation. For example, in a case that a DC pulse signal is input between the dimming line Dim and the ground line GND when the LED driver operates normally, the control signal being input to the terminals has a different duty cycle from that of the input signal of the terminals of the LED driver operating normally, or the control signal being input to the terminals has a different frequency from the input signal of the terminals of the LED driver operating normally. For example, in a case that a DC signal having amplitude within a certain range is input between the dimming line Dim and the ground line GND when the LED driver operates normally, the control signal being input to the terminals may be a DC signal having amplitude outside the above-described range. The control signal may be a signal having a type different from that of the input signal in normal operation. For example, in a case that the control signal being input between the dimming line Dim and the ground line GND when the LED driver operates normally is a DC signal, the control signal in step S101 may be another type of signal, such as, the DC pulse signal or the AC signal different from the DC signal.

In a case that terminals output a signal when the LED driver operates normally, the control signal is different from the output signal of the terminals of the LED driver operating normally means that: the control signal may be any input signal. The control signal may be any input signal since in normal operation the auxiliary power line Vcc and the ground line GND only output signals rather than receive signals.

In step S102, the fixed value of the LED driver is determined according to the control signal in a case that the control signal is detected.

The fixed value may be an output voltage value and/or an output current value of the LED driver.

In a case that the fixed value is the output voltage value of the LED driver, the fixed value may be a rated voltage value of the LED driver.

In a case that the fixed value is the output current value of the LED driver, the fixed value is a rated current of the LED driver in a case that the LED driver is an LED driver having no dimming function; and the fixed value includes an upper limit or a lower limit of the output current value of the LED driver in a case that the LED driver is an LED driver having a dimming function.

According to the embodiments of the present disclosure, an output rated current value or rated voltage value may be changed according to the control signal in a case that the LED driver is an LED driver having no dimming function; and the upper limit or the lower limit of an output current value may be changed according to the control signal in a case that the LED driver is an LED driver having a dimming function. Accordingly, only one LED driver is needed in an occasion where multiple LED drivers having different upper limits, lower limits, rated current values or rated voltage values were needed, and cost of LED drivers is saved. According to the embodiments of the present disclosure, the control signal is input to the existing terminals of the LED driver and no special lead is needed, thus the cost of the LED driver is further saved. Accordingly, a design of the LED driver is simplified, and it is beneficial for commercial standardization of the LED driver.

### Second Embodiment

Referring to FIG. 2, FIG. 2 is a flow chart of a second control method for controlling a fixed value of an LED driver according to an embodiment of the present disclosure. The method includes the following steps S201 to S203.

In step S201, it is detected whether a control signal is input to existing terminals of the LED driver.

In a case that the control signal is input between the dimming line Dim and the ground line GND, the control signal is different from the dimming signal. For example, when the LED driver operates normally, a signal allowed to be input between the dimming line Dim and the ground line GND is a voltage signal ranging from 0 V to 10 V, that is, the dimming signal is the voltage signal ranging from 0 V to 10 V, then the control signal can be any signal except for a level signal ranging from 0 V to 10 V. For example, the control signal may be a pulse signal, or the level signal having any amplitude above 10 V (not including 10 V).

In a case that the control signal is input between the auxiliary power line Vcc and the ground line GND, the control signal may be any signal. No signal is input between the auxiliary power line Vcc and the ground line GND and a voltage signal having stable amplitude is output between the auxiliary power line Vcc and the ground line GND, when the LED driver operates normally. Accordingly, the signal input between the auxiliary power line Vcc and the ground line GND of the LED driver can be recognized. For example, in a case that the voltage signal of 10 V is output when the LED driver operates normally, the control signal may be any signal, such as, a voltage signal of 5 V, a voltage signal of 10 V or a pulse signal.

In a case that the control signal is input between the positive output line Vo+ and the negative output line Vo−, the control signal may be any signal. Since no signal is input between the positive output line Vo+ and the negative output line Vo− and a current having stable amplitude is output between the positive output line Vo+ and the negative output line Vo−, when the LED driver operates normally, the control signal may be any signal, such as, a voltage signal of 12 V or a pulse signal.

In a case that the control signal is input between the input line Va and the input line Vb, the control signal is a signal different from the input voltage when the LED driver operates normally. For example, in a case that the LED driver operates normally, the signal allowed to be input between the input line Va and the input line Vb is a standard grid voltage signal, such as, a sinusoidal alternating voltage of 220 V, a sinusoidal alternating voltage of 230 V, a sinusoidal alternating voltage of 100 V or a sinusoidal alternating voltage of 110 V. And the control signal can be any signal except for the standard grid voltage signal. For example, the control signal may be a direct current signal, a pulse signal or an alternating voltage signal having a different frequency or amplitude from the grid voltage.

When it is detected by the LED driver that a signal different from the signal of the LED driver operating normally is input to the terminals, it may be considered that the control signal is received.

In step S202, a characteristic parameter of the control signal is analyzed in a case that the control signal is detected.

The characteristic parameter comprises one or more of an amplitude, a frequency, a duty cycle, high-level time and low-level time.

In step S203, a fixed value corresponding to the characteristic parameter is acquired.

The fixed value is a rated output voltage value of the LED driver in a case that the fixed value is the output voltage value of the LED driver.

The fixed value is a rated output current of the LED driver in a case that the fixed value is the output current value of the LED driver and the LED driver is an LED driver having no dimming function.

The fixed value includes an upper limit or a lower limit of the output current value of the LED driver, in a case that the fixed value is the output current value of the LED driver and the LED driver is an LED driver having a dimming function.

Specifically, it may be that the frequency of the control signal corresponds to the fixed value of the LED driver, the amplitude of the control signal corresponds to the fixed value of the LED driver; or the duty cycle of the control signal corresponds to the fixed value of the LED driver. Which characteristic parameter of the control signal corresponds to the fixed value of the LED driver, does not affect the implementation of the embodiments of the present disclosure and is not limited herein.

The embodiment of the present disclosure has advantageous effects of the first embodiment.

### Third Embodiment

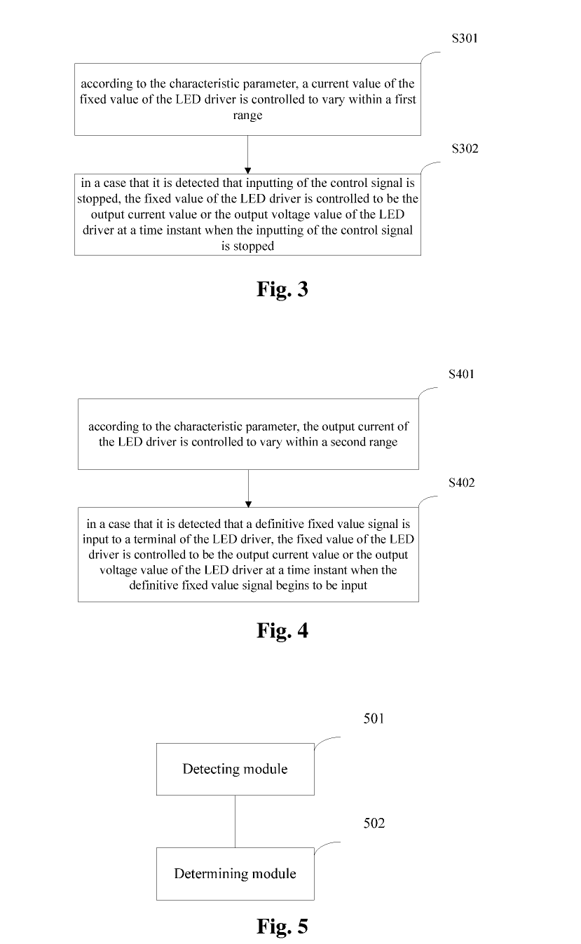

There are methods for acquiring the fixed value corresponding to the characteristic parameter in the above embodiment. Referring to FIG. 3, FIG. 3 is a flow chart of a first method for acquiring a fixed value corresponding to a characteristics parameter according to an embodiment of the disclosure. The method includes steps S301 and S302 as follows.

In step S301, according to the characteristic parameter, the fixed value of the LED driver is controlled to vary within a first range.

In a case that the fixed value is an output voltage value of the LED driver, the first range is a rated voltage range, and step S301 may be: controlling, according to characteristic parameter, the output voltage value of the LED driver to vary within the rated voltage range.

In a case that the fixed value is an output current value of the LED driver and the LED driver is an LED driver having no dimming function, the first range is a rated current range, and step S301 may be: controlling, according to characteristic parameter, the output current value of the LED driver to vary within the rated current range.

The characteristic parameter includes one or more of amplitude, a frequency, and a duty cycle. The LED driver may control the rated current of the LED driver to vary within the rated current range in a case that the control signal is detected.

The first range includes an upper limit current range or a lower limit current range, in a case that the fixed value is the output current value of the LED driver and the LED driver is an LED driver having a dimming function. Step S301 may be: controlling, according to a correspondence between the characteristic parameter and the upper limit current range, a maximum current output by the LED driver to vary within the upper limit current range. Or step S301 may be: controlling, according to a correspondence between the characteristic parameter and the lower limit current range, a minimum current output by the LED driver to vary within the lower limit current range.

In step S302, in a case that it is detected that the inputting of the control signal is stopped, the fixed value of the LED driver is controlled to be the output current value or the output voltage value of the LED driver at a time instant when inputting of the control signal is stopped.

In a case that the LED driver is an LED driving having a dimming function, step S302 may be: controlling the maximum current value of the LED driver to be the output current value of the LED driver at a time instant when inputting of the control signal is stopped, in a case that it is detected that the inputting of the control signal is stopped; or step S302 may be: controlling the minimum current value of the LED driver to be the output current value of the LED driver at a time instant when inputting of the control signal is stopped, in a case that it is detected that the inputting of the control signal is stopped.

According to the embodiment of the present disclosure, the output current value of the LED driver varies within the first range when the control signal is input to the LED driver. Preferably, a load may be connected to the LED driver to determine the fixed value of the LED driver. Accordingly, luminance variation of the load may be observed artificially, and inputting of the control signal is stopped once it is considered the luminance is appropriate.

### Fourth Embodiment

Referring to FIG. 4, FIG. 4 is a flow chart of a second method for acquiring a fixed value corresponding to a characteristic parameter according to an embodiment of the present disclosure. The method includes steps S401 and S402 as follows.

In step S401, according to the characteristic parameter, the output current of the LED driver is controlled to vary within a second range.

In step S402, in a case that it is detected that a definitive fixed value signal is input to terminals of the LED driver, the fixed value of the LED driver is controlled to be the output current value or the output voltage value of the LED driver at a time instant when the definitive fixed value signal begins to be input.

The above-described definitive fixed value signal has a different characteristic parameter from that of the control signal, or the above-described definitive fixed value signal has a different characteristic parameter value from that of the control signal.

The above-described definitive fixed value signal may have a different characteristic parameter from that of the control signal. For example, the definitive fixed value signal may be a pulse signal having a duty cycle of 20% in a case that the control signal is a pulse signal having a frequency varies within a certain range and having a constant duty cycle (such as a duty cycle of 70%). That is, in a case that the control signal being input to existing terminals of the LED driver is a pulse signal having a duty cycle of 70%, the pulse signal is considered as the control signal. In a case that a pulse signal having a duty cycle of 20% is input to the existing terminals of the LED driver, the pulse signal is considered as the definitive fixed value signal.

The above-described definitive fixed value signal may have a different characteristic parameter value from that of the control signal. For example, the control signal is a direct current level signal having the amplitude of 12 V, and the definitive fixed value signal may be a DC level signal having the amplitude of 15 V.

A third method for acquiring the fixed value corresponding to the characteristic parameter is provided according to the embodiment of the present disclosure. The method includes: obtaining the fixed value corresponding to the characteristic parameter according to the correspondence between the characteristic parameter and the fixed value. That is, there is a one-to-one correspondence between the characteristic parameter and the fixed value.

The method is described in detail in the above-described embodiment according to the present disclosure, and the method according to the present disclosure may be implemented by devices in multiple forms. A device is disclosed according to the present disclosure, and the device is explained in detail in a specific embodiment as follows.

The above-described correspondence between the characteristic parameter and the fixed value, correspondence between the characteristic parameter and the first range, or correspondence between the characteristic parameter and the second range may be preset by a digital circuit, or may be implemented by an analog circuit.

### Fifth Embodiment

Referring to FIG. 5, FIG. 5 is a structural schematic diagram of a device for controlling a fixed value of an LED driver according to an embodiment of the present disclosure. The device includes:

a detecting module 501 and a determining module 502.

The detecting module 501 is configured to detect whether a control signal is input to existing terminals of the LED driver.

The LED driver includes a first pair of terminals and a second pair of terminals, the first pair of terminals includes an input line Va and an input line Vb, the second pair of terminals includes a positive output line Vo+ and a negative output line Vo−, the existing terminals are any pair of terminals on the LED driver, and the control signal is different from an output signal or an input signal on the terminals of the LED driver operating normally.

The LED driver further includes a third pair of terminals, or the LED driver further includes a third pair of terminals and a fourth pair of terminals, wherein the third pair of terminals includes a dimming line Dim and a ground line GND, and the fourth pair of terminals includes a ground line GND and an auxiliary power line Vcc.

The determining module 502 is configured to determine the fixed value of the LED driver according to the control signal in a case that a detected result of the detecting module is yes.

The fixed value is an output rated voltage value of the LED driver in a case that the fixed value is an output voltage value of the LED driver.

The fixed value is a rated current value of the LED driver in a case that the fixed value is the output current value of the LED driver and the LED driver is an LED driver having no dimming function; the fixed value includes the upper limit or a lower limit of the output current of the LED driver, in a case that the fixed value is the output rated current value of the LED driver and the LED driver is an LED driver having a dimming function.

Different amplitude of a level signal correspond to a different fixed value of the LED driver in a case that the control signal is a level signal.

For example, in a case that the control signal is input between the dimming line Dim and the ground line GND, a signal allowed to be input between the two terminals when the LED driver operates normally is a voltage signal ranging from 0 V to 10 V, and the output current Io of the LED driver falls in a range of [0, 600 mA]. The control signal is a level signal having the amplitude different from the range from 0 V to 10 V, and different voltage amplitude of the control signal correspond to a different fixed value of the LED driver. For example, the fixed value that is the maximum value of the LED driver is set to 610 mA in a case that the control signal having the amplitude of 12 V is input between the dimming line Dim and the ground line GND. That is, in a case that the LED driver operates normally and a voltage ranging from 0 V to 10 V is input to the dimming line Dim and the ground line GND for dimming, the output current falls in a range of [0, 610 mA]; the fixed value that is the maximum value of the LED is set to 620 mA in a case that the control signal having voltage amplitude of 13 V is input to the two terminals. The output current falls in a range of [0, 620 mA] in a case that the LED driver operates normally and a voltage ranging from 0 V to 10 V is input to the line Dim and the line GND for dimming.

In a case that the control signal is a pulse signal, different duty cycles of the pulse signal correspond to different fixed values of the LED driver, or different frequencies (or periods) of the pulse signal correspond to different fixed values of the LED driver, or different amplitude of the pulse signal correspond to a different fixed value of the LED driver, or different high-level time (or low-level time) of the pulse signal correspond to a different fixed value of the LED driver.

The determining module 502 may include: a first analyzing unit, configured to analyze a characteristic parameter of the control signal, wherein the characteristic parameter includes one or more of amplitude, a frequency, a duty cycle, high-level time and low-level time; and an acquiring unit, configured to acquire a fixed value corresponding to the characteristic parameter.

The acquiring module may include: a first control sub-unit, configured to control the output current of the LED driver to vary within a first range according to the characteristic parameter; and a second control sub-unit, configured to control, in a case that it is detected that inputting of the control signal is stopped, the fixed value of the LED driver to be the output current value or the output voltage value of the LED driver at a time instant when the inputting of the control signal is stopped.

Or, the acquiring unit may include: a first control sub-unit, configured to control the output current of the LED driver to vary within a second range according to the characteristic parameter; and a third control sub-unit, configured to control, in a case that it is detected that a definitive fixed value signal is input by terminals of the LED driver, the fixed value of the LED driver to be the output current value or the output voltage value of the LED driver at a time instant when the definitive fixed value signal begins to be input, wherein the definitive fixed value signal has a different characteristic parameter from that of the control signal, or the definitive fixed value signal has a different characteristic parameter value from that of the control signal.

The acquiring unit is configured to acquire the fixed value corresponding to the characteristic parameter according to a correspondence between the characteristic parameter and the fixed value.

In order that the skilled in the art further understand the embodiments of the present disclosure, a specific example is taken to explain the above-described embodiment.

It is assumed that: the dimming signal being input between the dimming line Dim and the ground line GND ranges from 0 V to 10 V, and 0 V to 10 V linearly correspond to the output current [0, 350 mA] of the LED driver, in a case that the LED driver having a dimming function is in normal operating state. In a case that the control signal is input and the maximum value is set to 380 mA, the LED driver is in normal operating state again, and in a case that the dimming signal being input between the dimming line Dim and the ground line GND ranges from 0 V to 10 V, 0 V to 10 V linearly correspond to the output current [0, 380 mA] of the LED driver.

It is assumed that the output current is 350 mA in a case that the LED driver having no dimming function is in normal operating state. In a case that the control signal is input and the rated current value is set to 380 mA, the LED driver is in normal operating state again and the output current is 380 mA.

An LED driver including any device according to the above-described device embodiment is further disclosed according to the embodiment of the present disclosure.

The embodiments of the present disclosure are described herein in a progressive manner, with an emphasis placed on explaining the difference between each embodiment and the other embodiments. The same or similar parts among the embodiments can be referred to each other. For the device disclosed in the embodiments, the corresponding descriptions are relatively simple because the apparatus correspond to the methods disclosed in the embodiments. The relevant portions may be referred to the description of the method parts.

The steps of the method or algorithm described according to the embodiments disclosed herein can be implemented in forms of hardware, a software module executed by a processor or the combination of the both. The software module may be stored in a Random Access Memory (RAM), a memory, a Read-Only Memory (ROM), an electrically programmable ROM, an electrically erasable programmable ROM, a register, a hardware disk, a movable magnetic disk, CD-ROM or any other forms of storage medium well known in the art.

The above description of the embodiments disclosed herein enables those skilled in the art to implement or use the present disclosure. Numerous modifications to the embodiments will be apparent to those skilled in the art, and the general principle herein can be implemented in other embodiments without deviation from the spirit or scope of the present disclosure. Therefore, the present disclosure is not limited to the embodiments described herein, but in accordance with the widest scope consistent with the principle and novel features disclosed herein.

1. A control method for controlling a fixed value of an LED driver, comprising:
detecting whether a control signal is input to existing terminals of the LED driver, wherein the LED driver comprises a first pair of terminals and a second pair of terminals, the first pair of terminals comprises an input line Va and an input line Vb, the second pair of terminals comprises a positive output line Vo+ and a negative output line Vo−, the existing terminals are any pair of terminals of the LED driver, and the control signal is a signal different from an output signal or an input signal of the terminals of the LED driver operating normally; and
determining the fixed value of the LED driver according to the control signal in a case that the control signal is detected, wherein the fixed value is an output parameter of the LED driver and the output parameter is an output voltage value or an output current value,
wherein the fixed value is a rated current of the LED driver in a case that the fixed value is the output current value of the LED driver and the LED driver is an LED driver having no dimming function; or the fixed value comprises an upper limit or a lower limit of the output current value of the LED driver, in a case that the fixed value is the output current value of the LED driver and the LED driver is an LED driver having a dimming function.

2. The method according to claim 1, wherein the LED driver further comprises a third pair of terminals, or the LED driver further comprises a third pair of terminals and a fourth pair of terminals, wherein the third pair of terminals comprises a dimming line Dim and a ground line GND, and the fourth pair of terminals comprises a ground line GND and an auxiliary power line Vcc.

3. The method according to claim 1, wherein the process of determining the fixed value of the LED driver according to the control signal comprises:
analyzing a characteristic parameter of the control signal, wherein the characteristic parameter comprises one or more of amplitude, a frequency, a duty cycle, high-level time and low-level time; and
acquiring the fixed value corresponding to the characteristic parameter.

4. The method according to claim 3, wherein the process of acquiring the fixed value corresponding to the characteristic parameter comprises:
controlling the output parameter of the LED driver to vary within a first range according to the characteristic parameter; and
controlling, in a case that it is detected that inputting of the control signal is stopped, the fixed value of the LED driver to be the output current value or the output voltage value of the LED driver at a time instant when the inputting of the control signal is stopped.

5. The method according to claim 3, wherein the process of acquiring the fixed value corresponding to the characteristic parameter comprises:
controlling the output parameter of the LED driver to vary within a second range according to the characteristic parameter; and
controlling, in a case that it is detected that a definitive fixed value signal is input to terminals of the LED driver, the fixed value of the LED driver to be the output current value or the output voltage value of the LED driver at a time instant when the definitive fixed value signal begins to be input, wherein the definitive fixed value signal has a different characteristic parameter from that of the control signal, or the definitive fixed value signal has a different characteristic parameter value from that of the control signal.

6. The method according to claim 3, wherein the process of acquiring the fixed value corresponding to the characteristic parameter comprises:
acquiring the fixed value corresponding to the characteristic parameter according to a correspondence between the characteristic parameter and the fixed value.

7. A device for controlling a fixed value of an LED driver, comprising:
a detecting module, configured to detect whether a control signal is input to existing terminals of the LED driver, wherein the LED driver comprises a first pair of terminals and a second pair of terminals, the first pair of terminals comprises an input line Va and an input line Vb, the second pair of terminals comprises a positive output line Vo+ and a negative output line Vo−, the existing terminals are any pair of terminals of the LED driver, and the control signal is a signal different from an output signal or an input signal on the terminals of the LED driver operating normally; and
a determining module, configured to determine the fixed value of the LED driver according to the control signal in a case that a detected result of the detecting module is yes, wherein the fixed value is an output parameter of the LED driver and the output parameter is an output voltage value or an output current value,
wherein the fixed value is a rated current of the LED driver in a case that the fixed value is the output current value of the LED driver and the LED driver is an LED driver having no dimming function; or the fixed value comprises an upper limit or a lower limit of the output current value of the LED driver, in a case that the fixed value is the output current value of the LED driver and the LED driver is an LED driver having a dimming function.

8. The device according to claim 7, wherein the LED driver further comprises a third pair of terminals, or the LED driver further comprises a third pair of terminals and a fourth pair of terminals, wherein the third pair of terminals comprises a dimming line Dim and a ground line GND, and the fourth pair of terminals comprises a ground line GND and an auxiliary power line Vcc.

9. The device according to claim 7, wherein the determining module comprises:
a first analyzing unit, configured to analyze a characteristic parameter of the control signal, wherein the characteristic parameter comprises one or more of an amplitude, a frequency, a duty cycle, high-level time and low-level time; and
an acquiring unit, configured to acquire the fixed value corresponding to the characteristic parameter.

10. The device according to claim 9, wherein the acquiring module comprises:
a first control sub-unit, configured to control, according to the characteristic parameter, the output parameter of the LED driver to vary within a first range; and
a second control sub-unit, configured to control, in a case that it is detected that inputting of the control signal is stopped, the fixed value of the LED driver to be the output current value or the output voltage value of the LED driver at a time instant when the inputting of the control signal is stopped.

11. The device according to claim 9, wherein the acquiring unit comprises:
a first control sub-unit, configured to control, according to the characteristic parameter, the output parameter of the LED driver to vary within a second range; and
a third control sub-unit, configured to control, in a case that it is detected that a definitive fixed value signal is input by terminals of the LED driver, the fixed value of the LED driver to be the output current value or the output voltage value of the LED driver at a time instant when the definitive fixed value signal begins to be input, wherein the definitive fixed value signal has a different characteristic parameter from that of the control signal, or the definitive fixed value signal has a different characteristic parameter value from that of the control signal.

12. The device according to claim 9, wherein the acquiring unit is configured to:
acquire the fixed value corresponding to the characteristic parameter according to a correspondence between the characteristic parameter and the fixed value.

13. An LED driver comprising a device for controlling a fixed value of an LED driver, wherein the device for controlling a fixed value of an LED driver comprises:
a detecting module, configured to detect whether a control signal is input to existing terminals of the LED driver, wherein the LED driver comprises a first pair of terminals and a second pair of terminals, the first pair of terminals comprises an input line Va and an input line Vb, the second pair of terminals comprises a positive output line Vo+ and a negative output line Vo−, the existing terminals are any pair of terminals of the LED driver, and the control signal is a signal different from an output signal or an input signal on the terminals of the LED driver operating normally; and
a determining module, configured to determine the fixed value of the LED driver according to the control signal in a case that a detected result of the detecting module is yes, wherein the fixed value is an output parameter of the LED driver and the output parameter is an output voltage value or an output current value,
wherein the fixed value is a rated current of the LED driver in a case that the fixed value is the output current value of the LED driver and the LED driver is an LED driver having no dimming function; or the fixed value comprises an upper limit or a lower limit of the output current value of the LED driver, in a case that the fixed value is the output current value of the LED driver and the LED driver is an LED driver having a dimming function.

14. The LED driver according to claim 13, wherein the LED driver further comprises a third pair of terminals, or the LED driver further comprises a third pair of terminals and a fourth pair of terminals, wherein the third pair of terminals comprises a dimming line Dim and a ground line GND, and the fourth pair of terminals comprises a ground line GND and an auxiliary power line Vcc.

15. The LED driver according to claim 13, wherein the determining module comprises:
a first analyzing unit, configured to analyze a characteristic parameter of the control signal, wherein the characteristic parameter comprises one or more of an amplitude, a frequency, a duty cycle, high-level time and low-level time; and
an acquiring unit, configured to acquire the fixed value corresponding to the characteristic parameter.

16. The LED driver according to claim 15, wherein the acquiring module comprises:
a first control sub-unit, configured to control, according to the characteristic parameter, the output parameter of the LED driver to vary within a first range; and
a second control sub-unit, configured to control, in a case that it is detected that inputting of the control signal is stopped, the fixed value of the LED driver to be the output current value or the output voltage value of the LED driver at a time instant when the inputting of the control signal is stopped.

17. The LED driver according to claim 15, wherein the acquiring unit comprises:
a first control sub-unit, configured to control, according to the characteristic parameter, the output parameter of the LED driver to vary within a second range; and
a third control sub-unit, configured to control, in a case that it is detected that a definitive fixed value signal is input by terminals of the LED driver, the fixed value of the LED driver to be the output current value or the output voltage value of the LED driver at a time instant when the definitive fixed value signal begins to be input, wherein the definitive fixed value signal has a different characteristic parameter from that of the control signal, or the definitive fixed value signal has a different characteristic parameter value from that of the control signal.

18. The LED driver according to claim 15, wherein the acquiring unit is configured to:
acquire the fixed value corresponding to the characteristic parameter according to a correspondence between the characteristic parameter and the fixed value.

19. The method according to claim 2, wherein the process of determining the fixed value of the LED driver according to the control signal comprises:
analyzing a characteristic parameter of the control signal, wherein the characteristic parameter comprises one or more of amplitude, a frequency, a duty cycle, high-level time and low-level time; and
acquiring the fixed value corresponding to the characteristic parameter.
